(19) United States
(12) Patent Application Publication
(10) Pub. No.: US 2024/0290107 A1
(43) Pub. Date: Aug. 29, 2024

(54) VEHICLE AND METHOD FOR FACILITATING DETECTING AN OBJECT FALLEN FROM VEHICLE

(71) Applicant: Continental Autonomous Mobility Germany GmbH, Ingolstadt (DE)

(72) Inventors: Ajay Singh Tomar, Bangalore (IN); Bhanu Prakash Padiri, Bangalore (IN)

(73) Assignee: Continental Autonomous Mobility Germany GmbH, Ingolstadt (DE)

(21) Appl. No.: 18/574,014

(22) PCT Filed: Jun. 28, 2022
(86) PCT No.: PCT/EP2022/067716

§ 371 Date: Dec. 23, 2023

(30) Foreign Application Priority Data
Jun. 29, 2021 (GB) 2109311.7

(51) Int. Cl. G06V 20/58; B60Q 9/00; G06V 10/75; G06V 10/82

(52) U.S. Cl. CPC G06V 20/58; B60Q 9/00; G06V 10/75; G06V 10/82

(57) ABSTRACT

A vehicle and method for facilitating detecting an object fallen from the vehicle. The vehicle includes: a camera to obtain an image of an object for storing prior information when the object is loaded into the vehicle, and an image of vehicle front surroundings and an image of vehicle rear surroundings when the vehicle is moving; and a control unit to detect an object from the front surroundings image and an object from the rear surroundings image using the prior information, and to compare the detected object from the front surroundings image with the detected object from the rear surroundings image. I If the object is not detected from the front surroundings image but detected from the rear surroundings image, the control unit determines that the object has fallen from the vehicle, and controls an output unit to output a signal.

### CROSS-REFERENCE TO RELATED APPLICATIONS

The present application is a National Stage Application under 35 U.S.C. § 371 of International Patent Application No. PCT/EP2022/067716 filed on Jun. 28, 2022, and claims priority from United Kingdom Patent Application No. 2109311.7 filed on Jun. 29, 2021, in the United Kingdom Intellectual Property Office, the disclosures of which are herein incorporated by reference in their entireties.

### TECHNICAL FIELD

The present invention relates to a vehicle and a method for facilitating detecting an object in a road, and particularly relates to a vehicle and a method for facilitating detecting an object fallen from the vehicle.

### BACKGROUND

The following discussion of the background is intended to facilitate an understanding of the present disclosure only. It may be appreciated that the discussion is not an acknowledgement or admission that any of the material referred to was published, known or part of the common general knowledge of the person skilled in the art in any jurisdiction as at the priority date of the present application.

A vehicle is an apparatus used for transporting people or goods from one place to another place. The vehicle includes, but is not limited to, motor vehicles such as motorcycles, cars, buses and trucks, railed vehicles such as trains, and watercraft such as boats and ships.

With a popularization of the vehicles, there are growing needs on a safety and convenience for a driver of the vehicle. In line with this tendency, a variety of sensors and electronic devices is being developed to increase the safety and convenience for the driver.

For example, when the vehicle travels an expressway, objects such as obstacles may be present in the traveling route of the vehicle. The vehicle may detect the obstacle using images obtained by a camera and/or signals obtained by an infrared sensor, and then change the speed of the vehicle to prevent a collision with the obstacle.

However, conventionally, there has been no technology which can identify the obstacles fallen from the vehicle, and then alert the relevant information to the driver of the vehicle and/or another vehicles in the vicinity of the vehicle.

In light of the above, there exists a need to provide a solution that meets the mentioned needs at least in part.

### SUMMARY

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The present disclosure seeks to provide a vehicle and a method that addresses the aforementioned need at least in part.

The technical solution is provided in the form of a vehicle and a method for facilitating detecting an object fallen from the vehicle. The vehicle includes a camera operable to obtain an image of an object for storing prior information when the object is being loaded into the vehicle, and to obtain an image of front surroundings of the vehicle and an image of rear surroundings of the vehicle when the vehicle is moving. The vehicle further includes a control unit operable to detect an object from the image of the front surroundings and an object from the image of the rear surroundings using the prior information, and to compare the detected object from the image of the front surroundings with the detected object from the image of the rear surroundings so as to check if there is an object which is not detected from the image of the front surroundings but detected from the image of the rear surroundings. If so, the control unit is operable to determine that there is the fallen object from the vehicle, and to control the output unit to output the signal to alert a driver.

Therefore, the vehicle and the method in accordance with the present invention can identify the object fallen from the vehicle, and alert information of the fallen object to the driver of the vehicle and/or at least one another vehicle in the vicinity of the vehicle. As such, the driver of the vehicle can take the object back to the vehicle. In addition, the at least one another vehicle in the vicinity of the vehicle can avoid the object and/or the vehicle.

In accordance with an aspect of the present disclosure, there is a vehicle for facilitating detecting an object fallen from the vehicle, including: a camera operable to obtain an image of an object for storing prior information when the object is being loaded into the vehicle, and to obtain an image of front surroundings of the vehicle and an image of rear surroundings of the vehicle when the vehicle is moving; an output unit operable to output a signal; and a control unit operable to detect an object from the image of the front surroundings and an object from the image of the rear surroundings using the prior information, and to compare the detected object from the image of the front surroundings with the detected object from the image of the rear surroundings so as to check if there is an object which is not detected from the image of the front surroundings but detected from the image of the rear surroundings, wherein if there is the object which is not detected from the image of the front surroundings but detected from the image of the rear surroundings, the control unit is operable to determine that there is the fallen object from the vehicle, and to control the output unit to output the signal.

In some embodiments, the control unit is operable to reconstruct the image of the front surroundings to detect the object from the image of the front surroundings.

In some embodiments, the control unit is operable to detect the object from the image obtained when the object is being loaded into the vehicle, and to store the detected object from the image as the prior information.

In some embodiments, the object from the image is detected by a neural network.

In some embodiments, the control unit is operable to store the image of the object as the prior information, so that the image of the object is used for a correlation with the detected object from the image of the front surroundings and/or the detected object from the image of the rear surroundings.

In some embodiments, if it is determined that there is the fallen object from the vehicle, the output unit is operable to alert a driver of the vehicle with at least one of audio information, video information and haptic feedback to a steering wheel.

In some embodiments, if it is determined that there is the fallen object from the vehicle, the control unit is operable to inform another vehicle in vicinity of the vehicle, of an existence of the fallen object via wireless communication.

In some embodiments, if it is determined that there is the fallen object from the vehicle, the control unit is operable to monitor vehicle dynamics of the vehicle and modify a path of the vehicle to take the fallen object back.

In some embodiments, if the control unit modifies the path of the vehicle, the output unit is operable to display the modified path.

In some embodiments, if the control unit modifies the path of the vehicle, the control unit is operable to inform another vehicle in vicinity of the vehicle, of the modified path of the vehicle via wireless communication.

In accordance with another aspect of the present disclosure, there is a method for facilitating detecting an object fallen from the vehicle including steps of: obtaining an image of an object for storing prior information when the object is being loaded into the vehicle; obtaining an image of front surroundings of the vehicle and an image of rear surroundings of the vehicle when the vehicle is moving; detecting an object from the image of the front surroundings using the prior information; detecting an object from the image of the rear surroundings using the prior information; and comparing the detected object from the image of the front surroundings with the detected object from the image of the rear surroundings so as to check if there is an object which is not detected from the image of the front surroundings but detected from the image of the rear surroundings, wherein the method further includes steps of: if there is the object which is not detected from the image of the front surroundings but detected from the image of the rear surroundings, determining that there is the fallen object from the vehicle; and controlling an output unit to output a signal.

In some embodiments, the method further includes a step of reconstructing the image of the front surroundings to detect the object from the image of the front surroundings.

In some embodiments, the method further includes steps of detecting the object from the image obtained when the object is being loaded into the vehicle; and storing the detected object from the image as the prior information.

In some embodiments, the method further includes a step of storing the image of the object as the prior information, so that the image of the object is used for a correlation with the detected object from the image of the front surroundings and/or the detected object from the image of the rear surroundings.

In some embodiments, the method further includes a step of alerting a driver of the vehicle with at least one of audio information, video information and haptic feedback to a steering wheel, if it is determined that there is the fallen object from the vehicle.

In some embodiments, the method further includes a step of informing another vehicle in vicinity of the vehicle, of an existence of the fallen object via wireless communication, if it is determined that there is the fallen object from the vehicle.

Other aspects of the present disclosure will become apparent to those of ordinary skilled in the art upon review of the following description of specific embodiments of the present disclosure in conjunction with the accompanying drawings.

### BRIEF DESCRIPTION OF DRAWINGS

The present disclosure will now be described, by way of example only, with reference to the accompanying drawings, in which:

FIG. 1 is a block diagram in accordance with an embodiment of the present disclosure.

FIG. 2 is a block diagram in accordance with another embodiment of the present disclosure.

FIG. 3 is a flowchart in accordance with an embodiment of the present disclosure.

Other arrangements of the present disclosure are possible and, consequently, the accompanying drawings are not to be understood as superseding the generality of the preceding description of the invention.

### DETAILED DESCRIPTION

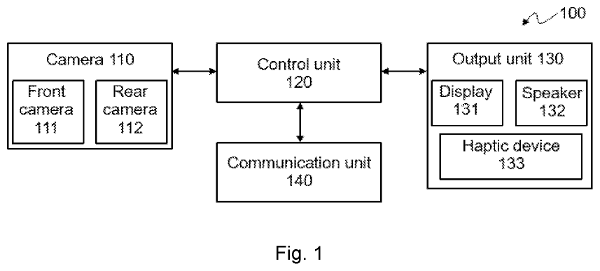

FIG. 1 is a block diagram in accordance with an embodiment of the present invention. As shown in FIG. 1, there is a vehicle 100. The vehicle 100 is an apparatus used for transporting people or goods from one place to another place. The vehicle 100 includes, but is not limited to, motor vehicles such as motorcycles, cars, buses and trucks, railed vehicles such as trains, and watercraft such as boats and ships. In some embodiments, the vehicle 100 is capable of loading objects.

The vehicle 100 includes, but is not limited to, a camera 110, a control unit 120 and an output unit 130.

The camera 110 may capture an image of an external environment. The captured image may be at least one of static image (also referred to as “still image”) and dynamic image (also referred to as “moving image” or “video”). The camera 110 may generate raw data. Thereafter, the control unit 120 may receive the raw data from the camera 110 and process, for example interpret, the raw data to obtain an image.

The obtained image may be stored in a memory (not shown). The memory may include, but not be limited to, an internal memory of the vehicle 110 and/or an external memory such as a cloud.

In some embodiments, the vehicle 100 may include a plurality of cameras 110. For example, the camera 110 includes at least one of a front camera, SV (Surround View) camera and RVS (Rear View) camera (also referred to as “rear camera”). The SV camera includes a fisheye lens which is an ultra-wide angle lens, to cover more field of view. The RVS camera includes at least one of the fisheye lens or a normal lens.

In some embodiments, the vehicle 100 may include the front camera 111 and the rear camera 112. It may be appreciated that the front camera 111 may be installed at the front side of the vehicle 100, and the rear camera 112 may be installed at the rear side of the vehicle 100. In some embodiments, the vehicle 100 may include a plurality of front cameras 111 and/or a plurality of rear cameras 112. In some embodiments, the vehicle 100 may further include at least one side camera installed in a side mirror of the vehicle 100.

The camera 110 is operable to obtain an image of an object, when the object is being loaded into the vehicle 100. For example, the object may include carton box, suitcase, bicycle, pet, and so on.

A control unit 120 may be referred to as a vehicle control unit. The vehicle control unit is an embedded system in automotive electronics which controls one or more of electrical systems or subsystems in the vehicle 100. The vehicle control unit may include an engine control unit (also referred to as “ECU”) operable to control an engine of the vehicle 100.

The control unit 120 is operable to detect the object from the image obtained when the object is being loaded into the vehicle 100, and to store the detected object from the image as prior information. In some embodiments, the object from the image may be detected by a neural network, for example an artificial neural network. The prior information may be stored in a memory (not shown). In this manner, the control unit 120 is able to know what objects are being placed inside the vehicle 100.

In some embodiments, the control unit 120 is operable to store the image of the object as the prior information, so that the image of the object is used for a correlation with the detected object from the image of the front surroundings of the vehicle 100 and/or the detected object from the image of the rear surroundings of the vehicle 100.

The camera 110 is further operable to obtain an image of front surroundings of the vehicle 100 and an image of rear surroundings of the vehicle 100, when the vehicle 100 is moving. In some embodiments, the front camera 111 is operable to obtain the image of the front surroundings of the vehicle 100, and the rear camera 112 is operable to obtain the image of the rear surroundings of the vehicle 100.

The output unit 130 is operable to output a signal, for example a visual signal, an audio signal and a haptic signal. The output unit 130 may include, but not be limited to, at least one of a display 131, a speaker 132 and a haptic device 133.

The display 131 is operable to display information processed by the control unit 120. For example, the display 131 may include a display installed in an instrument cluster. It may be appreciated that a plurality of displays may be provided. For example, the information may be displayed on the display installed in the instrument cluster and a head-up display.

The speaker 132 is operable to output audio signal. It may be appreciated that a plurality of speakers may be provided.

The haptic device 133 may include an actuator such as eccentric rotating mass actuator and/or piezoelectric actuator, and is operable to output a haptic signal, for example vibrations on a steering wheel.

In this manner, the output unit 130 is operable to alert a driver of the vehicle 100 with at least one of audio information, video information and haptic feedback to the steering wheel.

The control unit 120 is operable to detect an object from the image of the front surroundings of the vehicle 100 obtained when the vehicle 100 is moving, using the prior information. In some embodiments, the control unit 120 is operable to reconstruct the image of the front surroundings of the vehicle 100, to detect the object from the image of the front surroundings. In some embodiments, when a front camera 111 includes a fisheye lens, the image obtained by the front camera 111 may be rectified.

The control unit 120 is further operable to detect an object from the image of the rear surroundings of the vehicle 100 obtained when the vehicle 100 is moving, using the prior information. In some embodiments, when a rear camera 112 includes the fisheye lends, the image obtained by the rear camera 112 may be rectified.

The control unit 120 is then operable to compare the detected object from the image of the front surroundings with the detected object from the image of the rear surroundings, so as to check if there is an object which is not detected from the image of the front surroundings but detected from the image of the rear surroundings.

In some embodiments, the control unit 120 may check objects on a narrow field (for example, not outside of a road, but on the road). In some embodiments, the control unit 120 may compare frames of objects or count of objects from the image obtained from the front camera 111 at time “T-X” (where X depends on the speed of vehicle 100) with frames of objects or count of objects from the image obtained from the rear camera 112 at time “T”. When the vehicle 100 surpasses the detected object, the control unit 120 may compare the front camera view with the rear camera view.

In this manner, the control unit 120 may compare the detected object from the image of the front surroundings with the detected object from the image of the rear surroundings, by way of image correlation techniques or by count of intended objects (for example, object types loaded onto the vehicle 100 such as carton boxes, luggage, suitcase, etc.) detected. It may be appreciated that the control unit 120 may not consider vehicles as an object, because the vehicles are always on the road and front view count and rear view count are different from each other.

If there is an object which is not detected from the image of the front surroundings of the vehicle 100 but detected from the image of the rear surroundings of the vehicle 100, the control unit 120 is operable to determine that there is a fallen object from the vehicle 100. In addition, the control unit 120 is operable to control the output unit 130 to output the signal.

In some embodiments, a new object may be detected from the image of the front surroundings and not detected from the rear surroundings, if the object is moving in front of the vehicle 100 (for example, a carton box is tied to another vehicle and the vehicle 100 is following the another vehicle). The vehicle 100 may notice the object through the front camera 111 but not with the rear camera 112.

If it is determined that there is the fallen object from the vehicle 100, the output unit 130 is operable to alert the driver of the vehicle 100 with at least one of audio information, visual information and haptic feedback to the steering wheel. In some embodiments, the type of the alert may be set by the driver. For example, if the driver has set to receive the alert via the visual signal, the information of an existence of the fallen object is displayed in the display 131 of the vehicle 100.

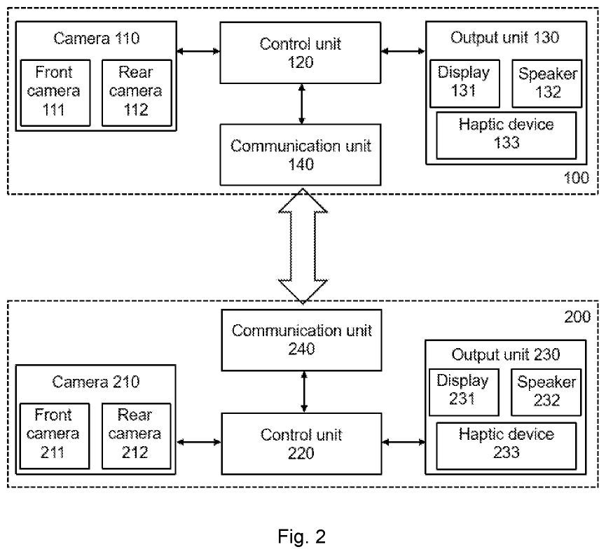

If it is determined that there is the fallen object from the vehicle 100, the control unit 120 is operable to inform another vehicle 200 in the vicinity of the vehicle 100, of an existence of the fallen object via wireless communication. The embodiments are to be described with FIG. 2.

FIG. 2 is a block diagram in accordance with another embodiment of the present disclosure.

As shown in FIG. 2, the vehicle 100 includes the camera 110, the control unit 120, the output unit 130 and a communication unit 140. The communication unit 140 may communicate with another vehicle 200 over a communications network. It may be appreciated that the communication unit 140 may communicate with an external device (for example, a mobile device) over the communication network.

The communication unit 140 may transmit and/or receive the information using a channel access method, for example Code-division multiple access (CDMA) or Time-division multiple access (TDMA). In some embodiments, the communication unit 140 may support wireless Internet access to communicate with another vehicle 200 and/or the external device. The wireless Internet access may include, but not be limited to, wireless LAN (for example, Wi-Fi), wireless broadband (Wi-bro) and worldwide interoperability for microwave access (Wi-max). In some embodiments, the communication unit 140 may support a short range communication to communicate with another vehicle 200 and/or the external device. The short range communication may include, but not be limited to, Bluetooth, Ultra-wideband (UWB), Radio Frequency Identification (RFID) and ZigBee.

In some embodiments, another vehicle 200 may include a camera 210, a control unit 220, an output unit 230 and a communication unit 240. The communication unit 240 may communicate with the communication unit 140 of the vehicle 100 over a communications network. It may be appreciated that the communication unit 140 may communicate with an external device (for example, a mobile device) over the communication network.

If the control unit 120 of the vehicle 100 (hereinafter referred to as “first vehicle”) determines that there is a fallen object from the first vehicle 100, the control unit 120 is operable to inform another vehicle 200 (hereinafter referred to as “second vehicle”) in the vicinity of the vehicle 100, of an existence of the fallen object via wireless communication.

In some embodiments, if the control unit 120 of the first vehicle 100 determines that there is the fallen object from the first vehicle 100, the control unit 120 is operable to monitor vehicle dynamics of the first vehicle 100 and modify a path of the first vehicle 100 to take the fallen object back. The vehicle dynamics may include, but not be limited to, a velocity, GPS position and acceleration.

If the control unit 120 of the first vehicle 100 modifies the path of the first vehicle 100, the output unit 130 of the first vehicle 100 is operable to inform the driver of the first vehicle 100 of the modified path. For example, the control unit 120 is operable to display the modified path on the display 131.

In some embodiments, if the control unit 120 of the first vehicle 100 modifies the path of the vehicle 100, the control unit 120 is operable to inform the second vehicle 200 in the vicinity of the first vehicle 100, of the modified path of the first vehicle 100 via the communication unit 140. In this manner, a driver of the second vehicle 200 can avoid any disruption or collision to be caused by the first vehicle 100.

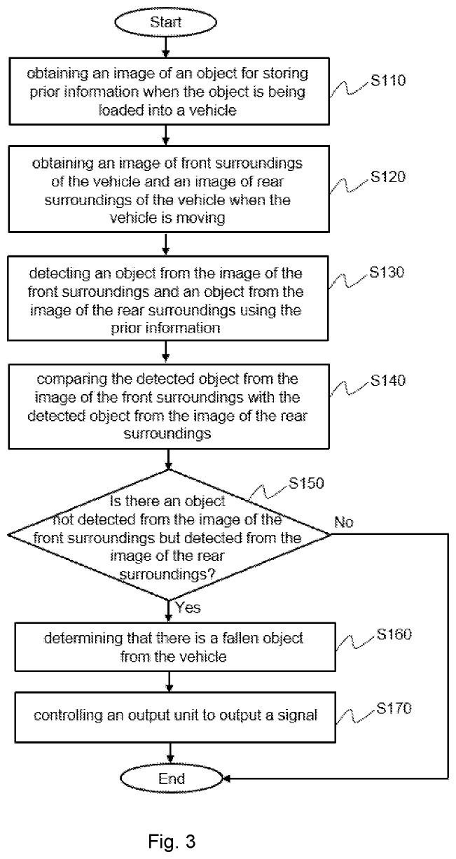

FIG. 3 is a flowchart in accordance with an embodiment of the present disclosure.

As shown in FIG. 3, a camera 110 of a vehicle 100 obtains an image of an object for storing prior information, when the object is being loaded into the vehicle 100 (S110). When the vehicle 100 is in a stationary position, objects are entered or loaded into the vehicle 100. The objects are scanned by the camera 110 including, not limited to, at least one front camera 111, at least one rear camera 112 and at least one side camera, to be identified and/or detected as objects (for example, carton box, suitcase, bicycle, pet, etc.). This procedure may help an algorithm to know what objects are being placed inside the vehicle 100. In some embodiments, this detection may be done by a neural network to detect generic objects. In some embodiments, the object image may be used for correlation with detected fallen object at later time.

The camera 110 obtains an image of front surroundings of the vehicle 100 and an image of rear surroundings of the vehicle 100 when the vehicle 100 is moving (S120). As the vehicle 100 is on the move, the camera 110 including, not limited to, at least one front camera 111, at least one rear camera 112 and at least one side camera, obtains the images of the surroundings of the vehicle 100.

A control unit 120 detects an object from the image of the front surroundings and an object from the image of the rear surroundings using the prior information (S130). In some embodiments, the control unit 120 reconstructs the image of the front surroundings of the vehicle 100, to detect the object from the image of the front surroundings. In this manner, the control unit 120 may detect if any objects are in the vicinity of the vehicle 100. In some embodiments, the control unit 120 detects an object using the image of the rear surroundings, to detect mainly for the prior information of the loaded objects in the vehicle 100.

The control unit 120 compares the detected object from the image of the front surroundings with the detected object from the image of the rear surroundings (S140). In some embodiments, the control unit 120 may check objects on a narrow field (for example, not outside of a road, but on the road). In some embodiments, the control unit 120 may compare frames of objects or count of objects from the image obtained from the front camera 111 at time “T-X” (where X depends on the speed of vehicle 100) with frames of objects or count of objects from the image obtained from the rear camera 112 at time “T”. When the vehicle 100 surpasses the detected object, the control unit 120 may compare the detected object from the image of the front surroundings with the detected object from the image of the rear surroundings.

The control unit 120 checks if there is an object not detected from the image of the front surroundings but detected from the image of the rear surroundings (S150). If there is the object not detected from the image of the front surroundings but detected from the image of the rear surroundings, the control unit 120 determines that there is a fallen object from the vehicle 100 (S160).

With this comparison of S140, the control unit 120 may determine if any new object is found in the rear camera 112. This is to identify an object which has fallen from the vehicle 100. In some embodiments, where an object type is not known, the input image obtained when the object was loaded into the vehicle 100 may be correlate with the image of the rear surroundings, to detect the fallen object. The results of the algorithm may be used as an input to the control unit 120, for example an ECU.

The control unit 120 controls an output unit 130 to output a signal (S170). The output unit 120 alerts a driver of the vehicle 100 with at least one of audio information, video information and haptic feedback to a steering wheel.

In some embodiments, as the vehicle 100 may plan to stop or halt to pick the fallen object, other vehicles in the vicinity of the vehicle 100 may need to take care of this possible situation. If V2X (vehicle-to-everything), which is a technology allowing the vehicle 100 to communicate with other vehicles and/or a traffic system, is enabled, the alert signal may be sent to other vehicles in the vicinity of the vehicle 100 to alert about the falling object and the possible situation.

In some embodiments, once the object falls (for example, in the night), the algorithm may keep track of vehicle dynamics including, but not limited to, velocity, GPS position, acceleration, etc. of the vehicle 100, and reconstruct the path where the object has fallen. This information on the reconstructed path may be displayed on a dashboard of the vehicle 100 to hint the driver of the vehicle 100 how he can trace back to take the fallen object back. This information may be shared with other vehicles in vicinity of the vehicle 100, so that they can avoid a lane relating to the reconstructed path well ahead.

Therefore, the vehicle 100 can identify the object fallen from the vehicle 100, and alert information of the fallen object to the driver of the vehicle 100 and/or at least one another vehicle 200 in the vicinity of the vehicle 100. As such, the driver of the vehicle 100 can take the object back to the vehicle 100. In addition, the at least one another vehicle 200 in the vicinity of the vehicle 100 can avoid the object and/or the vehicle 200.

While the present disclosure has been particularly shown and described with reference to exemplary embodiments thereof, it will be understood by those skilled in the art that various changes in form and details may be made therein without departing from the spirit and scope of the present disclosure as defined by the appended claims. However, this is merely an exemplarily embodiment, and those skilled in the art will recognize that various modifications and equivalents are possible in light of the above embodiments.

LIST OF REFERENCE SIGNS

| | |
|---|---|
| 100: Vehicle | 110: Camera |
| 111: Front camera | 112: Rear camera |
| 120: Control unit | 130: Output unit |
| 131: Display | 132: Speaker |
| 140: Communication unit | 200: Another vehicle |
| 210: Camera | 221: Front camera |
| 222: Rear camera | 220: Control unit |
| 230: Output unit | 231: Display |
| 232: Speaker | 240: Communication unit |

1. A vehicle for facilitating detecting an object fallen from the vehicle, comprising:
at least one camera operable to obtain an image of an object for storing prior information when the object is being loaded into the vehicle, and to obtain an image of front surroundings of the vehicle and an image of rear surroundings of the vehicle when the vehicle is moving;
an output unit operable to output a signal at an output of the output unit; and
a control unit comprising electronics and having an input coupled to an output of the at least one camera and an output coupled to an input of the output unit, the control unit operable to detect an object from the image of the front surroundings and an object from the image of the rear surroundings using the prior information, and to compare the detected object from the image of the front surroundings with the detected object from the image of the rear surroundings so as to check if there is an object which is not detected from the image of the front surroundings but detected from the image of the rear surroundings,
wherein if the object is not detected from the image of the front surroundings but detected from the image of the rear surroundings, the control unit is operable to determine that the object has fallen from the vehicle, and to control the output unit to output the signal.

2. The vehicle according to claim 1, wherein the control unit is operable to reconstruct the image of the front surroundings to detect the object from the image of the front surroundings.

3. The vehicle according to claims 1, wherein the control unit is operable to detect the object from the image obtained when the object is being loaded into the vehicle, and to store the detected object from the image as the prior information.

4. The vehicle according to claim 3, wherein the control unit includes a neural network and the object from the image is detected by the neural network.

5. The vehicle according to claim 1, wherein the control unit is operable to store the image of the object as the prior information, so that the image of the object is used for a correlation with at least one of the detected object from the image of the front surroundings and/or the detected object from the image of the rear surroundings.

6. The vehicle according to claims 1, wherein if it is determined by the control unit that the object has fallen from the vehicle, the output unit is operable to, with the output signal. alert a driver of the vehicle with at least one of audio information, video information and haptic feedback to a steering wheel.

7. The vehicle according to claims 1, wherein if is the control unit determines that the object has fallen from the vehicle, the control unit is operable to inform another vehicle in a vicinity of the vehicle, of an existence of the fallen object via wireless communication.

8. The vehicle according to claims 1, wherein if is the control unit determines that the object has fallen from the vehicle, the control unit is operable to monitor vehicle dynamics of the vehicle and modify a path of the vehicle to take the fallen object back.

9. The vehicle according to claim 8, wherein if the control unit modifies the path of the vehicle, the output unit is operable to display the modified path.

10. The vehicle according to claim 8, wherein if the control unit modifies the path of the vehicle, the control unit is operable to inform another vehicle in a vicinity of the vehicle, of the modified path of the vehicle via wireless communication.

11. A method for facilitating detecting an object fallen from the vehicle comprising:
obtaining, by at least one camera, an image of an object for storing prior information when the object is being loaded into the vehicle;
obtaining, by the at least one camera, an image of front surroundings of the vehicle and an image of rear surroundings of the vehicle when the vehicle is moving;
detecting, by a control unit including electronics and having an input coupled to an output of the at least one camera, an object from the image of the front surroundings using the prior information;
detecting, by the control unit, an object from the image of the rear surroundings using the prior information; and
comparing, by the control unit, the detected object from the image of the front surroundings with the detected object from the image of the rear surroundings so as to check if there is an object which is not detected from the image of the front surroundings but detected from the image of the rear surroundings ;-characterised-in-that:
if the object which is not detected from the image of the front surroundings but detected from the image of the rear surroundings, determining, by the control unit. that there is the object has fallen from the vehicle; and
controlling an output unit having an input coupled to an output of the control unit. to output a signal.

12. The method according to claim 11 further comprising reconstructing the image of the front surroundings to detect the object from the image of the front surroundings.

13. The method according to claims 11, further comprising: detecting the object from the image obtained when the object is being loaded into the vehicle; and storing the detected object from the image as the prior information.

14. The method according to claims 11, further comprising storing the image of the object as the prior information, so that the image of the object is used for a correlation with at least one of the detected object from the image of the front surroundings or the detected object from the image of the rear surroundings.

15. The method according to claims 11, further comprising alerting, by the output unit with the output signal appearing at the output of the output unit, a driver of the vehicle with at least one of audio information, video information and haptic feedback to a steering wheel, if it is determined that there is the fallen object from the vehicle.

16. The method according to claim 11, further comprising informing another vehicle in vicinity of the vehicle, of an existence of the fallen object via wireless communication, if it is determined by the control unit that the object has fallen from the vehicle.
